(19) United States
(12) Patent Application Publication
(10) Pub. No.: US 2019/0372947 A1
(43) Pub. Date: Dec. 5, 2019

(54) OPPORTUNISTIC ENCRYPTION OF A COMMUNICATION

(71) Applicant: Microsoft Technology Licensing, LLC, Redmond, WA (US)

(72) Inventors: Russell A. Penar, Highlands Ranch, CO (US); Amer A. Hassan, Kirkland, WA (US)

(21) Appl. No.: 15/994,623

(22) Filed: May 31, 2018

(51) Int. Cl. H04L 29/06; G06N 3/08

(52) U.S. Cl. CPC H04L 63/0471; G06N 3/08

(57) ABSTRACT

System and techniques for opportunistic encryptions of a communication are described herein. An identification of a communication that is not encrypted can be received along with a contextual element that corresponds to the communication. Network data can be selected based on the contextual element and processed to produce an encryption decision for the communication. A network segment of the communication can then be encrypted in response to the encryption decision.

### TECHNICAL FIELD

Embodiments described herein generally relate to communications systems and more specifically to opportunistic encryption of a communication.

### BACKGROUND

Modern communications are conducted over a myriad of physical and logical technologies. Physical technologies can include wired—e.g., Ethernet, fiber optics, etc.—and wireless—e.g., cellular standards such as those promulgated by the Third Generation Partnership Project (3GPP), wireless local or personal area networks such as those promulgated by the international the Institute of Electrical and Electronics Engineers (IEEE), such as IEEE 802.11 and IEEE 802.15.x standards—media. Logical technologies used can include a number of different protocols, such as the World Wide Web Consortium (W3C) Hypertext Transfer Protocol (HTTP), Transport Layer Security (TLS), Real-Time Transport Protocol (RTSP), among others. Together, these technologies support a variety of communication modalities, such as data transfers, messaging, video, and voice communications.

More and more communications are conducted, at least in part, over networks in which little control can be exercised. The Internet is an example of a network that carries communications in which the sender or receiver has little control over the hardware or software that interacts with the communications data. Further, the value of personal information (e.g., personally identifiable information (PII)) has grown; PII being valuable for targeted marketing of both products, news, as well as the possibility of manipulating people. PII is not only prevalent in many communications (e.g., interactions with social media applications), but can be required, such as in emergency call interactions where a caller's identity and location can be paramount to effective response by emergency personal.

For a variety of reasons, including protecting PII, security has also emerged as an important aspect of modern communications. Security can include a variety of different technologies to, for example, prevent unauthorized parties from observing data (e.g., secrecy), verifying that data has not been modified (e.g., integrity), and verifying an entity and its rights (e.g., authorization). Encryption often provides a framework for secrecy, obfuscating a communication unless a party has a valid key. Replay protection (e.g., via monotonic counters) and other cryptographic techniques (e.g., cryptographic hashes) can provide data integrity. Secure repositories or public key cryptography, or other trap-door techniques) can support authorization in the security ecosystem.

Connection technologies can be combined with security technologies to enable secure communication between parties. There are a number of different techniques to combine these elements. For example, two network devices can employ encryption between themselves, creating an encrypted tunnel, over which unencrypted data can be securely transmitted. In contrast, applications can encrypt data and between themselves, securely transferring the data without regard to encryption support from networks used. One thing that is generally common to secure communications, however, is an increase in signaling or processing overhead. Thus, for a given set of data and hardware, unencrypted communications often can be conducted in greater numbers, with less power consumption, with less hardware, in less time, etc.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 is a block diagram of an example of an environment including a system for opportunistic encryption of a communication, according to an embodiment.

FIG. 2 illustrates an example of an intelligent engine to implement a system for opportunistic encryption of a communication, according to an embodiment.

FIG. 3 illustrates an example of a format for a telephone call request, according to an embodiment.

FIG. 4 illustrates a flow diagram of an example of a method for opportunistic encryption of a communication, according to an embodiment.

FIG. 5 is a block diagram illustrating an example of a machine upon which one or more embodiments can be implemented.

### DETAILED DESCRIPTION

Encrypting all data in communications can provide security to users and their corresponding PII. However, as noted above, the increased resource use can lead to reduced capacity of networks to serve those same users. Further, many aspects of communications, such as silence on a voice communication, do not benefit from encryption. Accordingly, a technique to discern when to encrypt communications data and when to use unencrypted communications is needed.

A system for opportunistic encryption of a communication is herein described to provide encryption flexibility to both secure sensitive communications data while efficiently using network resources. The system combines communication context with network data to make encryption decisions for parts of communications without explicit direction from users. Examples of the communication context can include the time of the communication, the communication itself (e.g., voice data in a call) or metadata of the communication (e.g., identification of an emergency call, the initiator or receiver of the communication, etc.). Examples of the network data can include traffic on a network (e.g., volume, presence of Resource Priority Headers (RPH) or the like, etc.), an organization to which the initiator or receiver of the communication belongs (e.g., an employer, family, etc.), events pertinent to network segments (e.g., weather or geographical events such as earth quakes that can effect a network segment, social or security events such as protests or attacks that can pose heightened security risks, etc.), legal status of a user (e.g., presence of a warrant for the user), or other users or data of the network (e.g., detecting patterns in other communications that have, for example, explicitly requested encryption, or administrators that define patterns or people that should be encrypted, etc.).

The communication context (e.g., via a contextual element) is used to select which network data to investigate in order to convert an unencrypted communication to an encrypted communication without a user (e.g., initiator or receiver of the communication) explicitly requesting encryption. The same technique can be used to switch the now-encrypted communication back to unencrypted communication based on the communication context and the possibly changing network data. The encryption decision can be implemented in a variety of ways, including an inference engine (e.g., intelligent engine) that employs an artificial neural network or expert system to provide a statistical model comparing the benefits of encryption for a portion of the communication to the costs of encryption. The inference engine output can be combined with more static factors (e.g., an administrator directive to encrypt the user's business communications) to enable more explicit or fine-grained controls by responsible entities.

The resulting system for opportunistic encryption of a communication provides increased data security while optimizing resource (e.g., power, processing, or time) use across a communications system, all without burdening or relying on users to make explicit encryption decisions. For example, unsupervised learning in artificial neural networks can readily identify patterns. Such a process can be applied to user data for which encryption is requested. In communication where the encryption is implemented via tunneling, the data is unencrypted at some point and accessible to the unsupervised learning apparatus. Patterns are detected in the information—such as who is participating in the communication, or a type of data that is present in the communication—and learned by the artificial neural network. Then, the artificial neural network is applied to the unencrypted communication. When a trained pattern is recognized in the unencrypted communication, the artificial neural network can output a confidence of the pattern recognition that can be used in the encryption decision. Other examples can include recognized PII (e.g., name, address, salary, etc.), or the presence of RPH traffic, which can indicate heightened security threats on the network. Additional details and examples are described below.

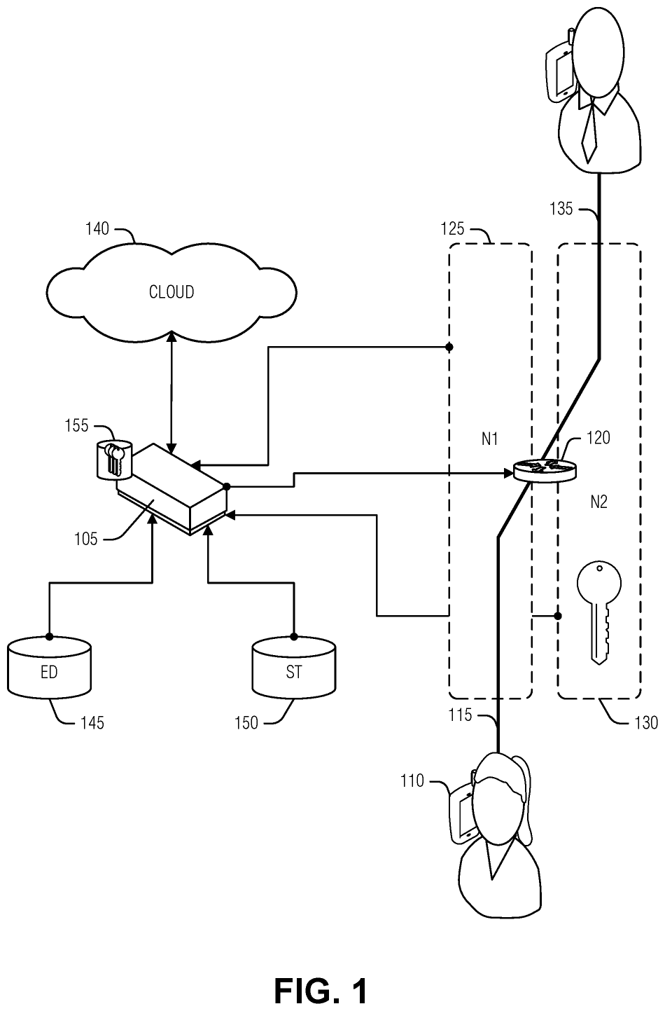

FIG. 1 is a block diagram of an example of an environment including a system for opportunistic encryption of a communication, according to an embodiment. The system can include an intelligent engine 105 that is communicatively coupled, when in operation, to one or more of a cloud 140, an external event data store 145, a synthetic transaction data store 150, a first network (N1) 125, a second network (N2) 130, or a network device 120 (e.g., a gateway, router, switch, multiplexer, etc.). The system can also include an authentication store 155 that is a part of, or otherwise accessible to, the intelligent engine 105.

To frame the following discussion, a user device 110 is communicating via the N1 125. Here, N1 125 is an unencrypted network. Based on an encryption decision by the intelligent engine 105, the network device 120 moves the communication from the unencrypted network segment 115 in N1 125 to an encrypted network segment 135 in the encrypted N2 130. N1 125 and N2 130 can be implemented as logical networks over the same physical hardware, as separate physical links (e.g., wires or wireless), or other arrangements in which the network segment 115 is unencrypted and the network segment 135 is encrypted.

The cloud 140, external event data store 145, synthetic transaction data store 150 are repositories of network data that the intelligent engine 105 can use to make encryption decisions for a communication starting at the user device 110. The external event data store 145 generally encompasses event data such as government alerts, news articles, weather reports, etc. that can be used to predict traffic need or security risks to, for example, the unencrypted N1 125. The synthetic transaction data store 150 generally encompasses data relating to predictive or simulated impacts on network performance For example, an estimate of the encrypted N2 130 can be stored following a traffic simulation of the N2 130. The cloud 140 generally encompasses settings or preference data for the user device 110, or to a user. For example, the cloud can include a user or administrator set risk tolerance level, data security classifications, etc. Although illustrated separately, the cloud 140, external event data store 145, synthetic transaction data store 150 can be collocated within a single data store, implemented wholly in a cloud architecture, edge architecture, peer-to-peer architecture, or other configuration by which the intelligent engine 105 can obtain (e.g., retrieve or receive) the data contained within these repositories.

The N1 125 and N2 130 can also provide network data to the intelligent engine 105. This network data can include such things as current traffic loads (e.g., how many connections, how many packets or frames, how many bits are being transferred, etc.), security issues (e.g., identified attacks on the network, etc.), or diagnostic information (e.g., network hardware errors or failures, etc.). Generally, the data from N1 125 or N2 130 represents a current state of the networks over which the communication is being conducted.

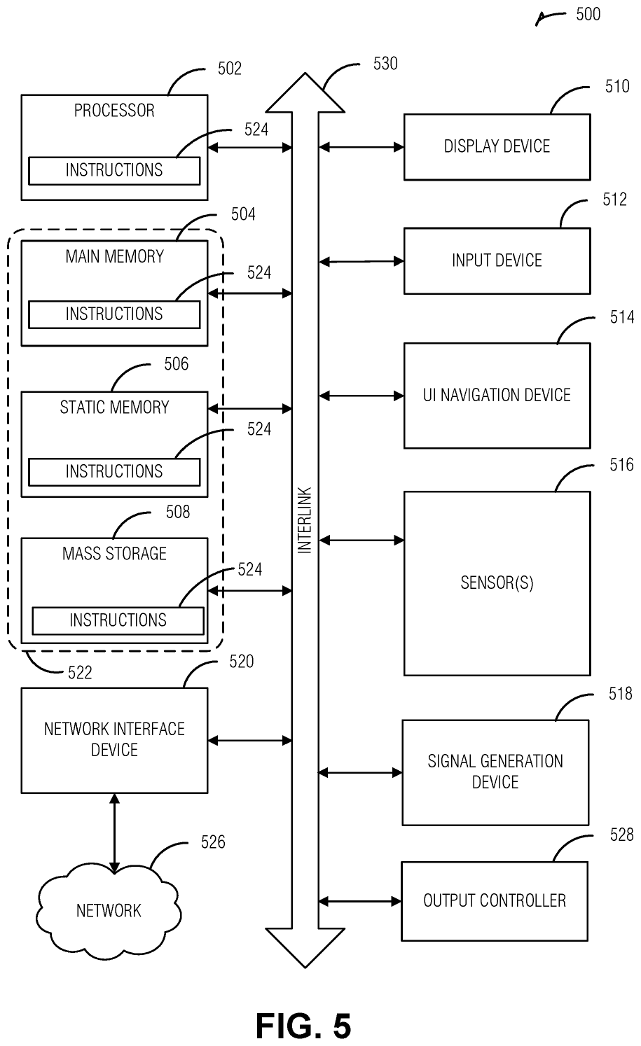

The intelligent engine 105 is implemented in hardware, such as processing circuitry, servers, etc. as described below with respect to FIG. 5. To implement opportunistic encryption of the communication, the intelligent engine is arranged to obtain a contextual element that corresponds to the communication. The contextual element is data relating to the context of the communication. Examples of contextual elements can include a time the communication is held, metadata of the communication (e.g., a sender or receiver, a location from or to the communication is conducted, etc.), or a sample of the communication itself (e.g., audio from a call). The contextual element can be generated by N1 125 or N2 130, stored in the cloud 140 (e.g., as a session, authentication, etc.), among other sources.

The intelligent engine 105 is arranged to select network data based on the contextual element. Again, the network data can be obtained from any or all of the cloud 140, external data store 145, synthetic transaction data store 150, the N1 125, or the N2 130. Selection of the network data based on the contextual element can take many forms, such as using a time for the communication to filter external events pertinent to the communication. In an example, the contextual element is the sample of the communication and the network data includes the sample of the communication. Here, the contextual element and the network data are the same thing. This correlation between the contextual element and the network data can be grounded in a type of contextual element obtained.

In an example, the contextual element is a time period and the network data can include a measure of resource priority headers (RPHs) within the time period. In an example, the measure of RPHs is at least one of a count of RPHs, a deviation from a norm of RPHs, or a rate of RPHs. Although a variety of network data characteristics can be filtered based on time period—such as network load, security threats, etc.—RPHs provide an interesting insight into external situations by a readily ascertainable network metric. Generally, RPHs are reserved for entities, like the military or emergency response services, to ensure prompt communication during a crisis. Thus, monitoring RPH activity can provide insight into a variety of issues, such as a disaster. Which RPH measurement is most appropriate can vary depending on the situation. Thus, a variety of measurements can be employed. For example, monitoring a rate of RPHs can provide a relatively straightforward threshold test to determine if the rate of RPHs indicates an emergency that can be more accurate than simply counting RPHs in, for example, where there is generally more RPH activity (e.g., a capital city). As noted below, emergencies, such as those posed by terrorist attacks, can warrant heightened security and thus justify greater encryption of communications.

In an example, the contextual element is metadata of the communication and the network data includes a type of communication. In an example, the type of communication is an emergency call. Emergency calls generally require location information for an individual, can indicate who the individual is, and can indicate that the person is vulnerable. This PII coupled with distress can make the individual vulnerable to predation. Thus, encrypting the PII can safeguard the individual from predators while enabling non-sensitive information to use the more efficient unencrypted N1 125.

In an example, the contextual element is the caller and the network data includes at least one of a vocation of the caller, relationships of the caller, activities of the caller, activities that identify the caller, or works of legal status of the caller. Here, a variety of factors can be relevant. For example, if the caller is a defense contractor, moving the communication to N2 130 is probably more beneficial than if the caller is a florist. Similarly, if the caller has many relationships with others who generally participate in encrypted communications, it is more likely that the caller's communication will benefit by encryption. In an example, activities of the caller include at least one of explicit activities or implicit activities. Explicit activities are those in which a human has performed a specific act in order to increase the likelihood of an encryption outcome. For example, law enforcement could register a warrant (e.g., in the cloud 140) or a warrant can be detected (e.g., via the external data store 145) for a user or the user device 110. Such an explicit activity can decrease the likelihood that the communication is encrypted. Another example of an explicit activity can include an administrator setting for the user to increase encryption on calls relating to an organization employing the administrator. In contrast, implicit activities are those that are not explicit activities. For example, an inference engine of the intelligent engine 105 could infer that a call is between a parent and a child from the sender or receiver identification, from location identification (e.g., from a home to a school), or from the content of the call itself (e.g., using automatic speech recognition (ASR) to discern aspects of the communication). In such a case, although no human has explicitly acted to secure the communication, the implicit activity can increase the likelihood that the communication will be encrypted.

The intelligent engine 105 is arranged to process the network data to produce an encryption decision for the communication. The processing can take many forms, such as providing the network data to an artificial neural network, an expert system, or applying a weighting formula, among others. In an example, explicit activities of the user are weighted more heavily than implicit activities. Such an arrangement enables explicit tuning of, for example, neural network or expert system assessments. In an example, the explicit activities are weighted at least five times greater than the implicit activities.

In an example, processing the network data includes increasing a likelihood of the encryption decision in response to detecting PII in the sample of the communication. This example enables PII to be detected in the communication and protected, relieving a concern for many users. In an example, processing the network data includes increasing a likelihood of the encryption decision in response to greater RPH measures. As noted above, RPH measures can be used to infer the appropriateness of increased security in light of, for example, a crisis. In an example, the encryption decision is made in response to the type of communication being an emergency call. As noted above, emergency communications can entail a vulnerable condition of the user that warrants further security.

In an example, processing the network data includes using a neural network created via unsupervised learning of communications that are designated as encrypted. For example, spiking neural networks employing spike timing dependent plasticity (STDP) learning inherently converge on patterns in input data. When coupled with neuromorphic hardware, these artificial neural networks can efficiently and continually train on data to ascertain patterns in communications themselves, or in related information (e.g., relationships or users similar to the user in location, occupation, place of employment, etc.) to connect that which should be encrypted to the communication when on the unencrypted network segment 115. In order for the unsupervised learning, or other pattern recognition technique, to operate, the training data is unencrypted, perhaps being transferred in a secure way via encrypted tunnels. In an example, processing the network data includes increasing the likelihood of the encryption decision in response to an increasing correlation between the encrypted communications and the communication.

The intelligent engine 105 is arranged to encrypt a network segment of the communication in response to the encryption decision. Again, the network segment is a portion of a network carrying the communication. For example, the illustrated network segment 135 is encrypted but could have started in the N1 125 and have been unencrypted prior to the intelligent engine's action to encrypt it. In an example, encrypting the network segment includes transitioning the communication from a first network segment (e.g., network segment 115) to a second network segment (e.g., network segment 135). This scenario is often applicable where, as illustrated, there are multiple networks that have different capabilities, such as the encrypted N2 130 and the unencrypted N1 125.

In an example, to encrypt the network segment, the intelligent engine 105 is arranged to instruct a first network device and a second network device to encrypt data between them. Here, the first network device and the second network device are endpoints for the network segment. For example, the user device 110 and the network device 120 could be the endpoints and the intelligent engine 105 instructs both to encrypt communications between them. This is a form of tunneling over intervening devices, such as uncontrolled, routers, gateways, switches, etc. In an example, a secure protocol, such as the secure real-time transport protocol (SRTP) can be employed to establish the encrypted network segment.

In an example, instructing the first network device and the second network device to encrypt data between them includes retrieving encryption parameters from the authentication store 155 (e.g., an Automatic Certificate Management Engine (ACME)) and communicating the encryption parameters to the first network device and the second network device. The authentication store 155 can be arranged to store known good encryption or routing information to reduce latency or increase security in establishing the encrypted segment. In an example, the authentication store 155 includes information that is regularly updated, such as changing keys between known devices, to decrease the likelihood that a given device's security is compromised.

In an example, the encryption can be established between two or more variable network nodes. Here, a variable network node is not fixed within the network, and can take on different roles in a network. Example variable nodes can include a mediation server, an intelligent agent, a gateway, etc. In an example, a mediation server queries a gateway to determine its encryption capabilities and uses those capabilities provided, if adequate, or supplements them with, for example, material from the authentication store 155. In an example, a controlled endpoint, such as device 110 is managed by the intelligent engine 105 (or the authentication store 155) to encrypt communications over an unencrypted network N1 125. For example, if the N2 130 network is at maximum capacity but the communication 115 is deemed to warrant encryption by the intelligent engine 105, the intelligent engine 105 can control (e.g., instruct) the device 110 to encrypt the communication 115 itself.

As noted earlier, not only can the communication be encrypted, but it can also be unencrypted. Again, this can increase network efficiency by using the less resource intensive unencrypted network N1 125 when appropriate. Thus, the intelligent engine 105 can be arranged to receive a second contextual element that corresponds to the communication when the network segment is encrypted, select second network data based on the second contextual element, process the second network data to produce a decryption decision for the communication, and decrypt the network segment in response to the decryption decision. Although the same data sources and technique described above are applicable to this process, they are naturally tuned (e.g., trained) to identify this opposite result. For example, a call can include a number of silent portions for which there is little value in encrypting the communication. This implicit data can then be used, when detected in the communication, to unencrypt time segments that represent silent gaps in a conversation.

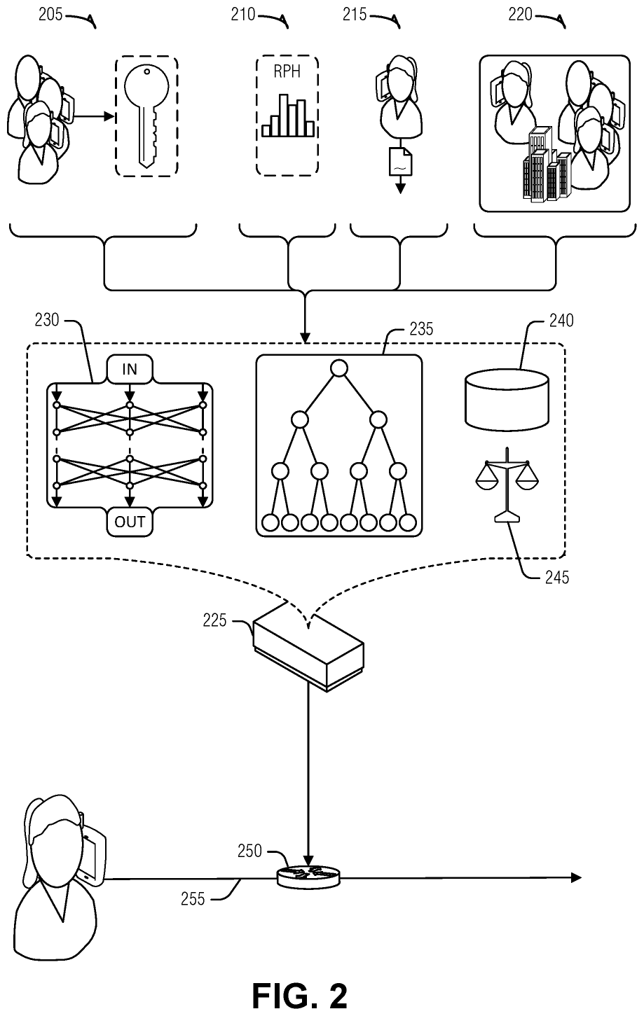

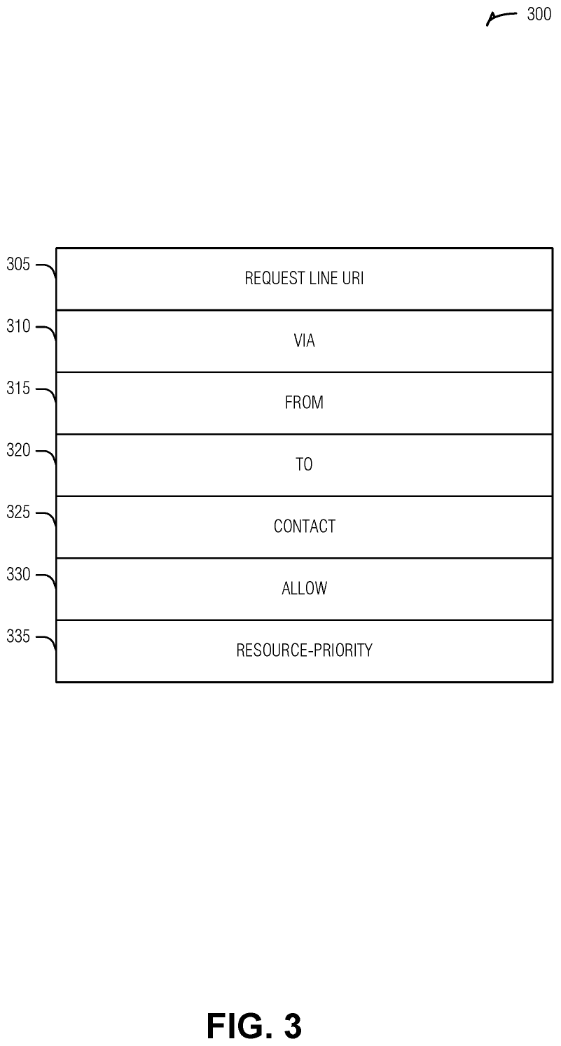

FIG. 2 illustrates an example of an intelligent engine 225 to implement a system for opportunistic encryption of a communication 255, according to an embodiment. The intelligent engine 225 can include one or more of an artificial neural network 230 (e.g., implemented in neuromorphic hardware), an expert system 235 (e.g., a decision tree, statistical model, etc.) a data store 240, and a weighting mechanism 245 (e.g., an explicit or approximated weighting formula) that are used to processing input data (e.g., deduced patterns of encryption 205, RPH measurements 210, communication data (e.g., the communication itself or metadata) 215, or user relationships 220, among others) to arrive at the encryption decision instruction for the network device 225 to implement encryption for the communication 255. In telephony communications employing SIP, RPH measurements 210 and some communication data 215 can be gleaned from telephony call requests (e.g., SIP requests), such as that illustrated in FIG. 3 and described below.

The artificial neural network 230 and the expert system 235 can effectively infer commonality (e.g., patterns) from large datasets to support implicit activity decisions for the intelligent engine 225. The data store 240 coupled with the weighting mechanism 245 can efficiently operate on input data to support explicit activity decisions. Further, the weighting mechanism 245 can be used to combine the implicit and explicit activity decisions to arrive at the encryption decision. The following examples illustrate interaction between these components of the intelligent engine 225 and the inputs in a variety of use cases.

Voice recognition can be used as a form of biometric recognition to, for example, recognize a communication 255 participant as a person flagged by an organization's administrator for increased encryption. Thus, the user's voice is part of the communication data that is recognized by the artificial neural network 230 and combined, by the weighting mechanism 245, with the administrator's flag stored in the data store 240 to arrive at the encryption decision. Conversely, if the intelligent engine 225 has been provided a court order (e.g., in the data store 240) to put all of the user's conversations into the clear (e.g., unencrypted), the intelligent engine 225 can do so without relying on typical, and often limited, limited identifiers such as source or destination telephone number.

External data (e.g., user relationships 220), such as social media articles, feed, or posts feeds, subscriptions to different modes of alert (e.g. SNMP, email, call, etc.), can be combined with communication intrinsic data (e.g., communication data 215) such as PII, interactive voice response (IVR) user requests, etc. and weighted by the artificial neural network 230, expert system 235, or the weighting mechanism 245 to account for its often direct correlation to a user desire to encrypt the communication 255.

An array of learned, and less directly connected indicators, such as unsupervised learning on deduced patterns of encryption 205 or user relationships 220 can be weighted to acknowledge the possibly less accurate inferences for encryption that can be drawn from these sources. However, some patterns that can be useful, in addition to those described above, can include patterns with a high correlation to events, such as, increasing traffic on calling corridors (e.g., macro, micro, aggregates) before users or administrators notice encryption is desirable.

In an example, to provide better training or correction data to the artificial neural network 230 or expert system 235 respectively, feedback from the user or an administrator can be solicited to determine the appropriateness of an encryption or decryption decision. For example, a prompt can be provided (e.g., on the communication 255 itself or in a side-channel such as an email) to the end-user at the end of the communication 255 (e.g., call). The prompt is arranged to illicit a response as to the appropriateness of encryption decision, or whether an encryption decision touch-point, such as PII, happened during the communication 255 for the call (or more concretely, if the PII sample encrypted is actually PII).

In an example, the intelligent engine 225 can provide reports of communications, PII, or encryption decisions to policy stakeholders (e.g., government regulators, administrators, etc.) to facilitate further training of models, or to provide explicit weighting parameters to the data store 240. In an example, policy stakeholders can provide feedback on the appropriateness of an encryption decision and store (e.g., in the data store 240) explicit weighting factors to correct a determined incorrect decision.

FIG. 3 illustrates an example of a format for a telephony call request 300, according to an embodiment. The illustrated call request message 300 is a SIP call request. The call request 300 includes a “REQUEST-LINE Uniform Resource Identifier (URI)” field 305, a “VIA” field 310, a “FROM” field 315, a “TO” field 320, a “CONTACT” field 325, an “ALLOW” field 330, and a “RESOURCE-PRIORITY” field 335 (e.g., RESOURCE-PRIORITY header). The REQUEST-LINE URI field 305 is a destination of a call. The VIA field 310 maintains an accumulating list of hops (e.g., network segments) as the call request 300 propagates through a network to the destination. For example, each proxy in a call path adds an entry (e.g., an address and port for the proxy) to the top of the VIA field 310. When a call response is processed, each proxy in the return path processes contents of the VIA field 310 in reverse order while also removing its own address from the top. For example, the VIA field 310 is organized as a first-in-last-out (FILO) data structure, such as a stack, and elements are “popped” off of the stack. The FROM field 315 stores the identity of an entity that imitated the request (e.g., an initiator). The FROM field 315 can include a URI or a display name (e.g., to show a human user or to store in logs).

The TO field 320 stores a target of the call request 300, such as a logical identifier, address, or record of a user or resource to which the call request 300 is targeted. The TO field 320 can include a SIP URI, but other addressing can also be used. The CONTACT field 325 contains an identifier (e.g., a SIP URI) that can be used to contact a sender of the call request 300. The ALLOW field 330 is a data structure maintaining supported communication methods (e.g., address, protocols, ports, encryption, etc.) supported by the requester (e.g., caller). In an example, the ALLOW field 330 can be formatted as a comma separated list of, for example, supported SIP methods. The SIP standard defines the following methods: ACK, BYE, CANCEL, INFO, INVITE, NOTIFY, OPTIONS, PRACK, REFER, REGISTER, SUBSCRIBE, UPDATE, which can be included in the ALLOW field 330. The RESOURCE-PRIORITY field 335 can include priority information for the call request 300. In an example, the RESOURCE-PRIORITY field 335 can include a resource-value field, a namespace field, or a priority field in accordance with a SIP RPH standard. The RESOURCE-PRIORITY field is generally used by network devices, such as routers, to prioritize some traffic over others, as can occur, for example, when government traffic is prioritized over civilian traffic in disaster response.

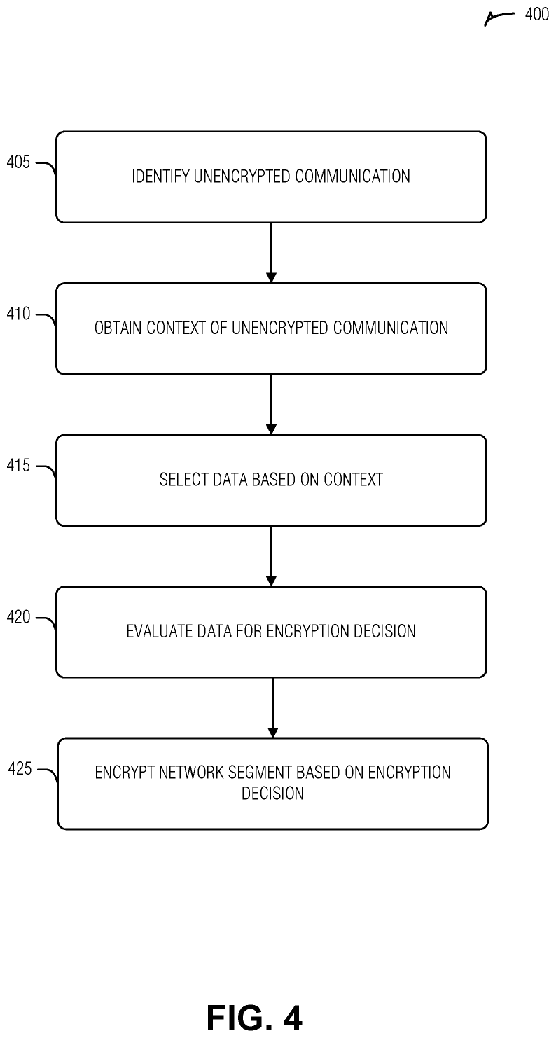

FIG. 4 illustrates a flow diagram of an example of a method 400 for opportunistic encryption of a communication, according to an embodiment. The operations of the method 400 are implemented in hardware, such as that described above (e.g., network hardware, inference engine, etc.) or below (e.g., processor or processing circuitry).

At operation 405, identification of a communication that is not encrypted is received. In an example, the communication is a voice communication. In an example, the voice communication is a telephony communication. In an example, the telephony communication uses a session initiation protocol (SIP) to establish a telephony session.

At operation 410, a contextual element that corresponds to the communication is received. Here, the contextual element is a piece of data that describes a context of the communication.

At operation 415, network data is selected based on the contextual element. In an example, the contextual element is the sample of the communication and the network data includes the sample of the communication.

In an example, the contextual element is a time period and the network data can include a measure of resource priority headers (RPHs) within the time period. In an example, the measure of RPHs is at least one of a count of RPHs, a deviation from a norm of RPHs, or a rate of RPHs.

In an example, the contextual element is metadata of the communication and the network data includes a type of communication. In an example, the type of communication is an emergency call.

In an example, the contextual element is the caller and the network data includes at least one of a vocation of the caller, relationships of the caller, activities of the caller, activities that identify the caller, or works of legal status of the caller. In an example, activities of the caller include at least one of explicit activities or implicit activities.

At operation 420, the network data is processed to produce an encryption decision for the communication. In an example, processing the network data includes increasing a likelihood of the encryption decision in response to detecting personally identifying information in the sample of the communication. In an example, processing the network data includes increasing a likelihood of the encryption decision in response to greater RPH measures. In an example, the encryption decision is made in response to the type of communication being an emergency call. In an example, processing the network data includes weighting explicit activities more heavily than implicit activities in arriving at the encryption decision.

In an example, processing the network data includes using a neural network created via unsupervised learning of encrypted communications. Here, the encrypted communications are designated as encrypted (e.g., in contrast to the unencrypted communication) but include unencrypted data that is transported via encrypted tunnels. In an example, processing the network data includes increasing the likelihood of the encryption decision in response to an increasing correlation between the encrypted communications and the communication.

At operation 425, a network segment of the communication is encrypted in response to the encryption decision. Here, the network segment is a portion of a network carrying the communication. In an example, encrypting the network segment includes transitioning the communication from a first network segment to a second network segment. Here, the first network segment is unencrypted and the second network segment is encrypted.

In an example, encrypting the network segment includes instructing a first network device and a second network device to encrypt data between them. Here, the first network device and the second network device are endpoints for the network segment. In an example, instructing the first network device and the second network device to encrypt data between them includes retrieving encryption parameters from an authentication store and communicating the encryption parameters to the first network device and the second network device.

The method 400 can optionally be extended to operate to move the now encrypted communication back to an unencrypted communication. These operations can include receiving a second contextual element that corresponds to the communication when the network segment is encrypted, selecting second network data based on the second contextual element, processing the second network data to produce a decryption decision for the communication, and decrypting the network segment in response to the decryption decision.

FIG. 5 illustrates a block diagram of an example machine 500 upon which any one or more of the techniques (e.g., methodologies) discussed herein can perform. Examples, as described herein, can include, or can operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 can operate as a standalone device or can be connected (e.g., networked) to other machines. In a networked deployment, the machine 500 can operate in the capacity of a server machine, a client machine, or both in server-client network environments. In an example, the machine 500 can act as a peer machine in peer-to-peer (P2P) (or other distributed) network environment. The machine 500 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 can include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drive, tape drive, flash storage, or other block devices) some or all of which can communicate with each other via an interlink (e.g., bus) 530. The machine 500 can further include a display unit 510, an alphanumeric input device 512 (e.g., a keyboard), and a user interface (UI) navigation device 514 (e.g., a mouse). In an example, the display unit 510, input device 512 and UI navigation device 514 can be a touch screen display. The machine 500 can additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 can include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 can be, or include, a machine readable medium 522 on which is stored one or more sets of data structures or instructions 524 (e.g., software) embodying or utilized by any one or more of the techniques or functions described herein. The instructions 524 can also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 can constitute the machine readable media 522. While the machine readable medium 522 is illustrated as a single medium, the term “machine readable medium” can include a single medium or multiple media (e.g., a centralized or distributed database, and/or associated caches and servers) configured to store the one or more instructions 524.

The term “machine readable medium” can include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples can include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 can be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 can include one or more physical jacks (e.g., Ethernet, coaxial, or phone jacks) or one or more antennas to connect to the communications network 526. In an example, the network interface device 520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### Additional Notes & Examples

Example 1 is a device for opportunistic encryption of a communication, the device comprising: processing circuitry; and a memory including instructions that, when executed by the processing circuitry, cause the processing circuitry to perform operations comprising: receiving identification of a communication that is not encrypted; receiving a contextual element that corresponds to the communication, the contextual element being a piece of data that describes a context of the communication; selecting network data based on the contextual element; processing the network data to produce an encryption decision for the communication; and encrypting a network segment of the communication in response to the encryption decision, the network segment being a portion of a network carrying the communication.

In Example 2, the subject matter of Example 1 includes, wherein the contextual element is a time period, and wherein the network data includes a measure of resource priority headers (RPHs) within the time period.

In Example 3, the subject matter of Example 2 includes, wherein the measure of RPHs is at least one of a count of RPHs, a deviation from a norm of RPHs, or a rate of RPHs.

In Example 4, the subject matter of Examples 2-3 includes, wherein processing the network data includes increasing a likelihood of the encryption decision in response to greater RPH measures.

In Example 5, the subject matter of Examples 1-4 includes, wherein the contextual element is metadata of the communication, and wherein the network data includes a type of communication.

In Example 6, the subject matter of Example 5 includes, wherein the type of communication is an emergency call, and wherein the encryption decision is in response to the emergency call type.

In Example 7, the subject matter of Examples 1-6 includes, wherein the contextual element is the caller, and wherein the network data includes at least one of a vocation of the caller, relationships of the caller, activities of the caller, activities that identify the caller, or works of legal status of the caller.

In Example 8, the subject matter of Example 7 includes, wherein activities of the caller include at least one of explicit activities or implicit activities.

In Example 9, the subject matter of Example 8 includes, wherein processing the network data includes weighting explicit activities more heavily than implicit activities in arriving at the encryption decision.

In Example 10, the subject matter of Examples 1-9 includes, wherein the contextual element is the sample of the communication, and wherein the network data includes the sample of the communication.

In Example 11, the subject matter of Example 10 includes, wherein processing the network data includes increasing a likelihood of the encryption decision in response to detecting personally identifying information in the sample of the communication.

In Example 12, the subject matter of Examples 1-11 includes, wherein processing the network data includes using a neural network created via unsupervised learning of encrypted communications, the encrypted communications being designated as encrypted and comprising unencrypted data that is transported in encrypted tunnels.

In Example 13, the subject matter of Example 12 includes, wherein processing the network data includes increasing the likelihood of the encryption decision in response to an increasing correlation between the encrypted communications and the communication.

In Example 14, the subject matter of Examples 1-13 includes, wherein encrypting the network segment includes transitioning the communication from a first network segment to a second network segment, wherein the first network segment is unencrypted and wherein the second network segment is encrypted.

In Example 15, the subject matter of Examples 1-14 includes, wherein encrypting the network segment includes instructing a first network device and a second network device to encrypt data between them, the first network device and the second network device being endpoints for the network segment.

In Example 16, the subject matter of Example 15 includes, wherein instructing the first network device and the second network device to encrypt data between them includes: retrieving encryption parameters from an authentication store; and communicating the encryption parameters to the first network device and the second network device.

In Example 17, the subject matter of Examples 1-16 includes, wherein the operations comprise: receiving identification of a communication that is not encrypted; receiving a second contextual element that corresponds to the communication when the network segment is encrypted; selecting second network data based on the second contextual element; processing the second network data to produce a decryption decision for the communication; and decrypting the network segment in response to the decryption decision.

In Example 18, the subject matter of Examples 1-17 includes, wherein the communication is a voice communication.

Example 19 is a method for opportunistic encryption of a communication, the method comprising: receiving identification of a communication that is not encrypted; receiving a contextual element that corresponds to the communication, the contextual element being a piece of data that describes a context of the communication; selecting network data based on the contextual element; processing the network data to produce an encryption decision for the communication; and encrypting a network segment of the communication in response to the encryption decision, the network segment being a portion of a network carrying the communication.

In Example 20, the subject matter of Example 19 includes, wherein the contextual element is a time period, and wherein the network data includes a measure of resource priority headers (RPHs) within the time period.

In Example 21, the subject matter of Example 20 includes, wherein the measure of RPHs is at least one of a count of RPHs, a deviation from a norm of RPHs, or a rate of RPHs.

In Example 22, the subject matter of Examples 20-21 includes, wherein processing the network data includes increasing a likelihood of the encryption decision in response to greater RPH measures.

In Example 23, the subject matter of Examples 19-22 includes, wherein the contextual element is metadata of the communication, and wherein the network data includes a type of communication.

In Example 24, the subject matter of Example 23 includes, wherein the type of communication is an emergency call, and wherein the encryption decision is in response to the emergency call type.

In Example 25, the subject matter of Examples 19-24 includes, wherein the contextual element is the caller, and wherein the network data includes at least one of a vocation of the caller, relationships of the caller, activities of the caller, activities that identify the caller, or works of legal status of the caller.

In Example 26, the subject matter of Example 25 includes, wherein activities of the caller include at least one of explicit activities or implicit activities.

In Example 27, the subject matter of Example 26 includes, wherein processing the network data includes weighting explicit activities more heavily than implicit activities in arriving at the encryption decision.

In Example 28, the subject matter of Examples 19-27 includes, wherein the contextual element is the sample of the communication, and wherein the network data includes the sample of the communication.

In Example 29, the subject matter of Example 28 includes, wherein processing the network data includes increasing a likelihood of the encryption decision in response to detecting personally identifying information in the sample of the communication.

In Example 30, the subject matter of Examples 19-29 includes, wherein processing the network data includes using a neural network created via unsupervised learning of encrypted communications, the encrypted communications being designated as encrypted and comprising unencrypted data that is transported in encrypted tunnels.

In Example 31, the subject matter of Example 30 includes, wherein processing the network data includes increasing the likelihood of the encryption decision in response to an increasing correlation between the encrypted communications and the communication.

In Example 32, the subject matter of Examples 19-31 includes, wherein encrypting the network segment includes transitioning the communication from a first network segment to a second network segment, wherein the first network segment is unencrypted and wherein the second network segment is encrypted.

In Example 33, the subject matter of Examples 19-32 includes, wherein encrypting the network segment includes instructing a first network device and a second network device to encrypt data between them, the first network device and the second network device being endpoints for the network segment.

In Example 34, the subject matter of Example 33 includes, wherein instructing the first network device and the second network device to encrypt data between them includes: retrieving encryption parameters from an authentication store; and communicating the encryption parameters to the first network device and the second network device.

In Example 35, the subject matter of Examples 19-34 includes, receiving identification of a communication that is not encrypted; receiving a second contextual element that corresponds to the communication when the network segment is encrypted; selecting second network data based on the second contextual element; processing the second network data to produce a decryption decision for the communication; and decrypting the network segment in response to the decryption decision.

In Example 36, the subject matter of Examples 19-35 includes, wherein the communication is a voice communication.

Example 37 is a machine readable medium including instructions for opportunistic encryption of a communication, the instructions, when executed by processing circuitry, cause the processing circuitry to perform operations comprising: receiving identification of a communication that is not encrypted; receiving a contextual element that corresponds to the communication, the contextual element being a piece of data that describes a context of the communication; selecting network data based on the contextual element; processing the network data to produce an encryption decision for the communication; and encrypting a network segment of the communication in response to the encryption decision, the network segment being a portion of a network carrying the communication.

In Example 38, the subject matter of Example 37 includes, wherein the contextual element is a time period, and wherein the network data includes a measure of resource priority headers (RPHs) within the time period.

In Example 39, the subject matter of Example 38 includes, wherein the measure of RPHs is at least one of a count of RPHs, a deviation from a norm of RPHs, or a rate of RPHs.

In Example 40, the subject matter of Examples 38-39 includes, wherein processing the network data includes increasing a likelihood of the encryption decision in response to greater RPH measures.

In Example 41, the subject matter of Examples 37-40 includes, wherein the contextual element is metadata of the communication, and wherein the network data includes a type of communication.

In Example 42, the subject matter of Example 41 includes, wherein the type of communication is an emergency call, and wherein the encryption decision is in response to the emergency call type.

In Example 43, the subject matter of Examples 37-42 includes, wherein the contextual element is the caller, and wherein the network data includes at least one of a vocation of the caller, relationships of the caller, activities of the caller, activities that identify the caller, or works of legal status of the caller.

In Example 44, the subject matter of Example 43 includes, wherein activities of the caller include at least one of explicit activities or implicit activities.

In Example 45, the subject matter of Example 44 includes, wherein processing the network data includes weighting explicit activities more heavily than implicit activities in arriving at the encryption decision.

In Example 46, the subject matter of Examples 37-45 includes, wherein the contextual element is the sample of the communication, and wherein the network data includes the sample of the communication.

In Example 47, the subject matter of Example 46 includes, wherein processing the network data includes increasing a likelihood of the encryption decision in response to detecting personally identifying information in the sample of the communication.

In Example 48, the subject matter of Examples 37-47 includes, wherein processing the network data includes using a neural network created via unsupervised learning of encrypted communications, the encrypted communications being designated as encrypted and comprising unencrypted data that is transported in encrypted tunnels.

In Example 49, the subject matter of Example 48 includes, wherein processing the network data includes increasing the likelihood of the encryption decision in response to an increasing correlation between the encrypted communications and the communication.

In Example 50, the subject matter of Examples 37-49 includes, wherein encrypting the network segment includes transitioning the communication from a first network segment to a second network segment, wherein the first network segment is unencrypted and wherein the second network segment is encrypted.

In Example 51, the subject matter of Examples 37-50 includes, wherein encrypting the network segment includes instructing a first network device and a second network device to encrypt data between them, the first network device and the second network device being endpoints for the network segment.

In Example 52, the subject matter of Example 51 includes, wherein instructing the first network device and the second network device to encrypt data between them includes: retrieving encryption parameters from an authentication store; and communicating the encryption parameters to the first network device and the second network device.

In Example 53, the subject matter of Examples 37-52 includes, wherein the instructions comprise: receiving identification of a communication that is not encrypted; receiving a second contextual element that corresponds to the communication when the network segment is encrypted; selecting second network data based on the second contextual element; processing the second network data to produce a decryption decision for the communication; and decrypting the network segment in response to the decryption decision.

In Example 54, the subject matter of Examples 37-53 includes, wherein the communication is a voice communication.

Example 55 is a system for opportunistic encryption of a communication, the system comprising: means for receiving identification of a communication that is not encrypted; means for receiving a contextual element that corresponds to the communication, the contextual element being a piece of data that describes a context of the communication; means for selecting network data based on the contextual element; means for processing the network data to produce an encryption decision for the communication; and means for encrypting a network segment of the communication in response to the encryption decision, the network segment being a portion of a network carrying the communication.

In Example 56, the subject matter of Example 55 includes, wherein the contextual element is a time period, and wherein the network data includes a measure of resource priority headers (RPHs) within the time period.

In Example 57, the subject matter of Example 56 includes, wherein the measure of RPHs is at least one of a count of RPHs, a deviation from a norm of RPHs, or a rate of RPHs.

In Example 58, the subject matter of Examples 56-57 includes, wherein the means for processing the network data include means for increasing a likelihood of the encryption decision in response to greater RPH measures.

In Example 59, the subject matter of Examples 55-58 includes, wherein the contextual element is metadata of the communication, and wherein the network data includes a type of communication.

In Example 60, the subject matter of Example 59 includes, wherein the type of communication is an emergency call, and wherein the encryption decision is in response to the emergency call type.

In Example 61, the subject matter of Examples 55-60 includes, wherein the contextual element is the caller, and wherein the network data includes at least one of a vocation of the caller, relationships of the caller, activities of the caller, activities that identify the caller, or works of legal status of the caller.

In Example 62, the subject matter of Example 61 includes, wherein activities of the caller include at least one of explicit activities or implicit activities.

In Example 63, the subject matter of Example 62 includes, wherein the means for processing the network data include means for weighting explicit activities more heavily than implicit activities in arriving at the encryption decision.

In Example 64, the subject matter of Examples 55-63 includes, wherein the contextual element is the sample of the communication, and wherein the network data includes the sample of the communication.

In Example 65, the subject matter of Example 64 includes, wherein the means for processing the network data include means for increasing a likelihood of the encryption decision in response to detecting personally identifying information in the sample of the communication.

In Example 66, the subject matter of Examples 55-65 includes, wherein the means for processing the network data include means for using a neural network created via unsupervised learning of encrypted communications, the encrypted communications being designated as encrypted and comprising unencrypted data that is transported in encrypted tunnels.

In Example 67, the subject matter of Example 66 includes, wherein the means for processing the network data include means for increasing the likelihood of the encryption decision in response to an increasing correlation between the encrypted communications and the communication.

In Example 68, the subject matter of Examples 55-67 includes, wherein the means for encrypting the network segment include means for transitioning the communication from a first network segment to a second network segment, wherein the first network segment is unencrypted and wherein the second network segment is encrypted.

In Example 69, the subject matter of Examples 55-68 includes, wherein the means for encrypting the network segment include means for instructing a first network device and a second network device to encrypt data between them, the first network device and the second network device being endpoints for the network segment.

In Example 70, the subject matter of Example 69 includes, wherein the means for instructing the first network device and the second network device to encrypt data between them include: means for retrieving encryption parameters from an authentication store; and means for communicating the encryption parameters to the first network device and the second network device.

In Example 71, the subject matter of Examples 55-70 includes, means for receiving identification of a communication that is not encrypted; means for receiving a second contextual element that corresponds to the communication when the network segment is encrypted; means for selecting second network data based on the second contextual element; means for processing the second network data to produce a decryption decision for the communication; and means for decrypting the network segment in response to the decryption decision.

In Example 72, the subject matter of Examples 55-71 includes, wherein the communication is a voice communication.

Example 73 is at least one machine-readable medium including instructions that, when executed by processing circuitry, cause the processing circuitry to perform operations to implement of any of Examples 1-72.

Example 74 is an apparatus comprising means to implement of any of Examples 1-72.

Example 75 is a system to implement of any of Examples 1-72.

Example 76 is a method to implement of any of Examples 1-72.

The above detailed description includes references to the accompanying drawings, which form a part of the detailed description. The drawings show, by way of illustration, specific embodiments that can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device for opportunistic encryption of a communication, the device comprising:
processing circuitry; and
a memory including instructions that, when executed by the processing circuitry, cause the processing circuitry to perform operations comprising:
receiving identification of a communication that is not encrypted;
receiving a contextual element that corresponds to the communication, the contextual element being a piece of data that describes a context of the communication;
selecting network data based on the contextual element;
processing the network data to produce an encryption decision for the communication; and
encrypting a network segment of the communication in response to the encryption decision, the network segment being a portion of a network carrying the communication.

2. The device of claim 1, wherein the contextual element is a time period, and wherein the network data includes a measure of resource priority headers (RPHs) within the time period.

3. The device of claim 2, wherein processing the network data includes increasing a likelihood of the encryption decision in response to greater RPH measures.

4. The device of claim 1, wherein the contextual element is the sample of the communication, and wherein the network data includes the sample of the communication.

5. The device of claim 4, wherein processing the network data includes increasing a likelihood of the encryption decision in response to detecting personally identifying information in the sample of the communication.

6. The device of claim 1, wherein encrypting the network segment includes transitioning the communication from a first network segment to a second network segment, wherein the first network segment is unencrypted and wherein the second network segment is encrypted.

7. The device of claim 1, wherein the communication is a voice communication.

8. A method for opportunistic encryption of a communication, the method comprising:
receiving identification of a communication that is not encrypted;
receiving a contextual element that corresponds to the communication, the contextual element being a piece of data that describes a context of the communication;
selecting network data based on the contextual element;
processing the network data to produce an encryption decision for the communication; and
encrypting a network segment of the communication in response to the encryption decision, the network segment being a portion of a network carrying the communication.

9. The method of claim 8, wherein the contextual element is a time period, and wherein the network data includes a measure of resource priority headers (RPHs) within the time period.

10. The method of claim 9, wherein processing the network data includes increasing a likelihood of the encryption decision in response to greater RPH measures.

11. The method of claim 8, wherein the contextual element is the sample of the communication, and wherein the network data includes the sample of the communication.

12. The method of claim 11, wherein processing the network data includes increasing a likelihood of the encryption decision in response to detecting personally identifying information in the sample of the communication.

13. The method of claim 8, wherein encrypting the network segment includes transitioning the communication from a first network segment to a second network segment, wherein the first network segment is unencrypted and wherein the second network segment is encrypted.

14. The method of claim 8, wherein the communication is a voice communication.

15. A system for opportunistic encryption of a communication, the system comprising:
means for receiving identification of a communication that is not encrypted;
means for receiving a contextual element that corresponds to the communication, the contextual element being a piece of data that describes a context of the communication;
means for selecting network data based on the contextual element;
means for processing the network data to produce an encryption decision for the communication; and
means for encrypting a network segment of the communication in response to the encryption decision, the network segment being a portion of a network carrying the communication.

16. The system of claim 15, wherein the contextual element is a time period, and wherein the network data includes a measure of resource priority headers (RPHs) within the time period.

17. The system of claim 16, wherein the means for processing the network data include means for increasing a likelihood of the encryption decision in response to greater RPH measures.

18. The system of claim 15, wherein the contextual element is the sample of the communication, and wherein the network data includes the sample of the communication.

19. The system of claim 18, wherein the means for processing the network data include means for increasing a likelihood of the encryption decision in response to detecting personally identifying information in the sample of the communication.

20. The system of claim 15, wherein the means for encrypting the network segment include means for transitioning the communication from a first network segment to a second network segment, wherein the first network segment is unencrypted and wherein the second network segment is encrypted.

21. The system of claim 15, wherein the communication is a voice communication.
